(19) United States
(12) Patent Application Publication
(10) Pub. No.: US 2017/0046898 A1
(43) Pub. Date: Feb. 16, 2017

(54) BIOMETRIC AND BLUETOOTH ENABLED VEHICLE CONSOLE AND GLOVE BOX LOCK

(71) Applicant: iWALLET CORPORATION, San Diego, CA (US)

(72) Inventor: Steven D. Cabouli, San Diego, CA (US)

(21) Appl. No.: 15/230,602

(22) Filed: Aug. 8, 2016

Related U.S. Application Data
(60) Provisional application No. 62/203,366, filed on Aug. 10, 2015.

(51) Int. Cl. G07C 9/00; E05B 81/08; E05B 17/10; E05B 81/56; E05B 81/74; E05B 83/30; E05B 81/06

(52) U.S. Cl. CPC G07C 9/00563; E05B 83/30; E05B 81/08; E05B 81/06; E05B 81/56; E05B 81/74; E05B 17/10; G07C 9/00896; G07C 9/00944

(57) ABSTRACT

The present invention is directed to a Biometric and Bluetooth enabled vehicle Console and Glove Box Lock that provides a unique apparatus for locking enclosures such as any locking compartment within a vehicle as well as the vehicle doors, vehicle hood and vehicle trunk locks, and the like, with indirect operational control by the means of a smartphone, tablet or a computer. The Biometric and Bluetooth enabled vehicle Console and Glove Box Lock contains a biometric based finger print authentication module, and a Bluetooth/RF COMM communications enabled module, to prevent a non-owner or unauthorized user from accessing the device.

### FIELD OF THE INVENTION

This application provides a unique apparatus for locking a wide variety of vehicle enclosures such as consoles, glove boxes, trunks and access hatches including boats and airplanes with indirect operational control by the means of a smartphone, tablet or a computer. More particularly, a Biometric and Bluetooth enabled vehicle Console and Glove Box Lock is provided which can be used with any locking compartment within a vehicle or vessel as well as the vehicle or vessel doors, vehicle hood and vehicle trunk locks.

### BACKGROUND OF THE INVENTION

The present invention pertains generally to a wide variety of enclosures with improved security features. More specifically, the present invention pertains to systems and methods for securing enclosures such as consoles, glove boxes, trunks and access hatches, and the like, while employing electronic features communicating with a smartphone, tablet or a computer. The present invention is particularly useful as a method with advanced features including biometric authentication and an ability to transmit and receive electronic signals.

In an age where electronic devices and transactions are prevalent, safe-guarding data within enclosures such as consoles, glove boxes, trunks and access hatches, and the like, has become an important issue, thus giving rise to a myriad of security systems. Two of the common security systems used are, password and personal identification (PIN) systems. Password systems require a user to provide the authentication system with a username and a password (both of which are unique to the user). PIN systems on the other hand usually require a user to provide a code, usually referred to as the PIN code, for authentication purposes. Both the password and the PIN system can prove to be a nuisance to users in the event they forget their password or PIN code. Moreover, a user A can easily impersonate another user B if user A happens to get a hold of the password or PIN code (given either voluntarily or exploited through other means) of user B. One way to avoid such breaches of security is to implement a user-based physiological or behavioral characteristic as a means for authentication. This is the general idea behind biometrics.

Biometrics is the study of measurable biological characteristics. In computer security, biometrics refers to authentication techniques that rely on measurable physiological (e.g. face, fingerprint, hand, iris, or DNA) or behavioral (e.g. keystrokes, signature, or voice) characteristics that can be automatically checked.

In the above description, authentication is usually accomplished via a biometric device. A general description of the functionality of a biometric device now follows. First, the biometric device captures a profile of the characteristic and next, a comparison of the acquired profile is made with a stored profile or template. Lastly, upon successful matching of the captured and stored profile, the user is interfaced with the application system requesting authentication.

Authentication based on fingerprint: One of the most common biometric techniques is the fingerprint, wherein users scan in a copy of their fingerprint and a comparison is performed by the authentication device as to whether or not the input fingerprint matches that of a stored fingerprint corresponding to the same person. Some fingerprint authentication devices further provide a step of checking for a pulse to combat problems posed by false-authentication via fingerprints that are not real.

Authentication based on hand geometry captures the physical characteristics of a user's hand and fingers via a scanner and is matched with a stored template of the same user. Upon successful authentication, an action (like opening a secure door) is performed by the querying system.

Therefore, biometrics is beginning to play a critical role in authentication and security. Biometrics authenticate the user not based on what he can remember (like passwords, PIN's, etc.), but rather use the user's characteristics (or who the user is) to perform authentication.

Also recently, improvements in electronic tracking and inventory systems have been proposed that take advantage of the latest short range, low power technologies such as Bluetooth and ZigBee. However, no similar proposals have been made that specifically address enclosures such as securing enclosures such as consoles, glove boxes, trunks and access hatches as in the Biometric and Bluetooth enabled vehicle Console and Glove Box Lock application, providing biometric authentication and electronic tracking.

### SUMMARY OF THE INVENTION

In this respect, before explaining at least one embodiment of the Biometric and Bluetooth enabled vehicle Console and Glove Box Lock in detail it is to be understood that the design is not limited in its application to the details of construction and to the arrangement, of the components set forth in the following description or illustrated in the drawings. The Biometric and Bluetooth enabled vehicle Console and Glove Box Lock is capable of other embodiments and of being practiced and carried out in various ways. In addition, it is to be understood that the phraseology and terminology employed herein are for the purpose of description and should not be regarded as limiting. As such, those skilled in the art will appreciate that the conception, upon which this disclosure is based, may readily be utilized as a basis for designing of other structures, methods and systems for carrying out the several purposes of the present design. It is important, therefore, that the claims be regarded as including such equivalent construction insofar as they do not depart from the spirit and scope of the present application.

The principle advantage of the Biometric and Bluetooth enabled vehicle Console and Glove Box Lock is that it provides a unique apparatus for locking enclosures such as consoles, glove boxes, trunks, hoods and access hatches, and the like with indirect operational control by the means of a smartphone, tablet or a computer.

Another advantage of the Biometric and Bluetooth enabled vehicle Console and Glove Box Lock is that it contains a biometric based authentication module to prevent a non-owner from accessing the device. Biometrics authenticate the user not based on what he can remember but rather use the user's characteristics to perform authentication.

Another advantage of the Biometric and Bluetooth enabled vehicle Console and Glove Box Lock is that it contains a Bluetooth communications enabled based authentication module to prevent a non-owner from accessing the device and provides secure consoles, glove boxes, trunks and access hatches that are tamper resistant.

Another advantage of the Biometric and Bluetooth enabled vehicle Console and Glove Box Lock is that it provides secure locking consoles, glove boxes, trunks and access hatches with electronic transmission and receiving capability.

Another advantage of the Biometric and Bluetooth enabled vehicle Console and Glove Box Lock is that it will provide vehicle consoles, glove boxes, trunks and access hatches with a USB port so that data can be retrieved, stored and programmed to the device via a personal smartphone or laptop computer.

Another advantage of the Biometric and Bluetooth enabled vehicle Console and Glove Box Lock is that it will provide secure consoles, glove boxes, trunks and access hatches system and method that is simple to use, yet easy to implement and cost effective.

The Biometric and Bluetooth enabled vehicle Console and Glove Box Lock provides a unique apparatus for locking enclosures such as consoles, glove boxes, trunks and access hatches with indirect operational control by the means of a smartphone, tablet or a computer. The Biometric and Bluetooth enabled vehicle Console and Glove Box Lock is provided having relatively low power, relatively short range, and wireless transmission capability. The Biometric and Bluetooth enabled vehicle Console and Glove Box Lock can be unlocked or locked at any distance within the range of the cell phone. The Biometric and Bluetooth enabled vehicle Console and Glove Box Lock is still further configured so that when it is separated by a predetermined distance, for example ten (10) feet, the Biometric and Bluetooth enabled vehicle Console and Glove Box Lock will provide audio and/or vibrational indication to both the Biometric and Bluetooth enabled vehicle Console and Glove Box Lock and the cell phone. The audio indication principle purpose is to alert an owner when the Biometric and Bluetooth enabled vehicle Console and Glove Box Lock has been stolen.

In a preferred embodiment, a biometric reader is realized as fingerprint module microprocessor that controls the actions of the range detection, for example with sound generator and vibrator, and also with authentication of the user via the fingerprint module. A Security Parameter Index (SPI) is associated with a Biometric and Bluetooth enabled vehicle Console and Glove Box Lock owner's biometric signature. Microprocessor communicates to wireless module via a General Purpose Input/Output (GPIO), for example, and includes antenna. It is preferred that both processor and wireless module are low power consuming and concurrent with the latest advancements in such electronics. Further, the wireless module is configured, according to for example, short range low power protocols as defined by either Bluetooth, ZigBee (IEEE 802.15.4), Radio Frequency Identification (RFID), or Ultra-Wideband (UWB).

The present design comprises applications including registration, login, authentication, range detection, wireless stack, security library, biometric middleware, operating system, and device drivers. The operating system includes all the services such as interprocess communications, memory management, clock, and file system. Device drivers include wireless, flash, I/O ports, timers, fingerprint reader, and others. Sitting on top of the OS are the wireless communication stack, biometric library (middleware), and security library. The application layer includes applications such as sync, user registration, user authentication, and range detection, for example.

In the Biometric and Bluetooth enabled vehicle Console and Glove Box Lock a biometric reader is configured to scan a fingerprint of a person attempting to access the Biometric and Bluetooth enabled vehicle Console and Glove Box Lock. The LED is designed to emit green when processor recognizes the fingerprint as the owner. Also, a chime is emitted from sound generator when a successful authentication is received. Additionally, LED is designed to emit red light, and sound generator will emit a warning buzzer, when the biometric reader scans a fingerprint other than what the processor recognizes as the owner. Still further, LED is designed to emit amber light when battery power for the device is below a threshold level and also sound generator will emit an intermittent beeping sound. In a preferred embodiment, recharging of the battery power can be achieved via the mini USB port to a charger that plugs into an AC power supply. Alternatively, a separate port for an AC adapter can be provided as a design choice.

With respect to the above description then, it is to be realized that the optimum dimensional relationships for the parts of this application, to include variations in size, materials, shape, form, function and manner of operation, assembly and use, are deemed readily apparent and obvious to one skilled in the art. All equivalent relationships to those illustrated in the drawings and described in the specification intend to be encompassed by the present disclosure. Therefore, the foregoing is considered as illustrative only of the principles of the Biometric and Bluetooth enabled vehicle Console and Glove Box Lock. Further, since numerous modifications and changes will readily occur to those skilled in the art, it is not desired to limit the design to the exact construction and operation shown and described, and accordingly, all suitable modifications and equivalents may be resorted to, falling within the scope of this application.

### BRIEF DESCRIPTION OF THE DRAWINGS

The accompanying drawings, which are incorporated in and form a part of this specification, illustrate embodiments of the Biometric and Bluetooth enabled vehicle Console and Glove Box Lock and together with the description, serve to explain the principles of this application.

FIG. 1 depicts a perspective view of the Biometric and Bluetooth enabled vehicle Console and Glove Box Lock components.

FIG. 2 depicts an exploded view of the Biometric and Bluetooth enabled vehicle Console and Glove Box Lock components.

FIG. 3 depicts a perspective view of a typical vehicle instrument panel incorporating the Biometric and Bluetooth enabled vehicle Console and Glove Box Lock.

FIG. 4 depicts a detail view of a portion of the instrument panel illustrating the Biometric and Bluetooth activation buttons.

FIG. 5 depicts a perspective view of a typical vehicle center console incorporating the Biometric and Bluetooth enabled vehicle Console and Glove Box Lock.

FIG. 6 depicts a detail view of a portion of the center console illustrating the Biometric and Bluetooth activation buttons.

FIG. 7 depicts a perspective view of the Biometric and Bluetooth enabled vehicle Console and Glove Box Lock components with the latching mechanism prior to locking engagement with the locking bar.

FIG. 8 depicts a perspective view of the Biometric and Bluetooth enabled vehicle Console and Glove Box Lock components with the latching mechanism in a partial engagement position with the locking bar.

FIG. 9 depicts a perspective view of the Biometric and Bluetooth enabled vehicle Console and Glove Box Lock components with the latching mechanism in a full locking engagement position with the locking bar.

FIG. 10 depicts a perspective view of the Biometric and Bluetooth enabled vehicle Console and Glove Box Lock components with the latching mechanism separated from the locking bar.

FIG. 11A depicts a block diagram illustration of the system for securing the Biometric and Bluetooth enabled vehicle Console and Glove Box Lock, including the motor control, lock, Bluetooth antenna and Bluetooth module as well as optional mass storage, GPS and motion sensor.

FIG. 11B depicts a block diagram illustration of the hardware components for the Biometric and Bluetooth enabled vehicle Console and Glove Box Lock assembly, including the main processor, speaker driver and speaker, as well as the USB port and battery power supply configurations.

FIG. 11C depicts a block diagram illustration hardware and software components for the Biometric and Bluetooth enabled vehicle Console and Glove Box Lock assembly, including the fingerprint reader, internal lights and user interface.

For a fuller understanding of the nature and advantages of the Biometric and Bluetooth enabled vehicle Console and Glove Box Lock, reference should be had to the following detailed description taken in conjunction with the accompanying drawings which are incorporated in and form a part of this specification, illustrate embodiments of the design and together with the description, serve to explain the principles of this application.

### DETAILED DESCRIPTION OF THE PREFERRED EMBODIMENTS

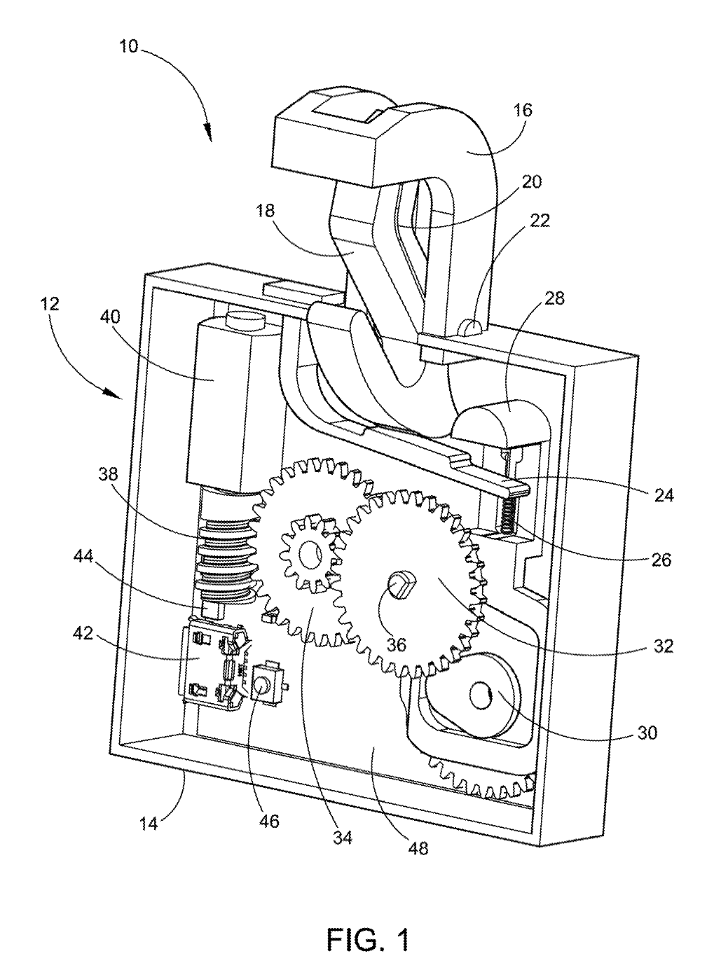

Referring now to the drawings, wherein similar parts of the Biometric and Bluetooth enabled vehicle Console and Glove Box Lock 10 are identified by like reference numerals, there is seen in FIG. 1 a perspective view of the Biometric and Bluetooth enabled vehicle Console and Glove Box Lock components 12. The components 12 consist of the lock enclosure 14, with the latch housing 16 attached by the means of the latch mechanism 18 and latch spring 20 pivoting on the latch hinge pin 22. The lever 24 maintains pressure on the lock mechanism 18 by the means of the latch spring 26 against the latch link 28 that is actuated by the cam on the thirty tooth gear 30. The thirty-two tooth—twelve tooth gear 32A and 32B, the thirty-two tooth/twelve tooth gear 34 rotating on the drive shaft 36, are driven by the worm gear 38 on the motor 40. The USB charging unit 42, the unit reset button 44 and the Bluetooth button 46 are attached to the PCB (printed circuit board) 48. The PCB (printed circuit board) 54 controlling the functions of the Biometric and Bluetooth enabled vehicle Console and Glove Box Lock 10 is coupled to the Bluetooth button 46.

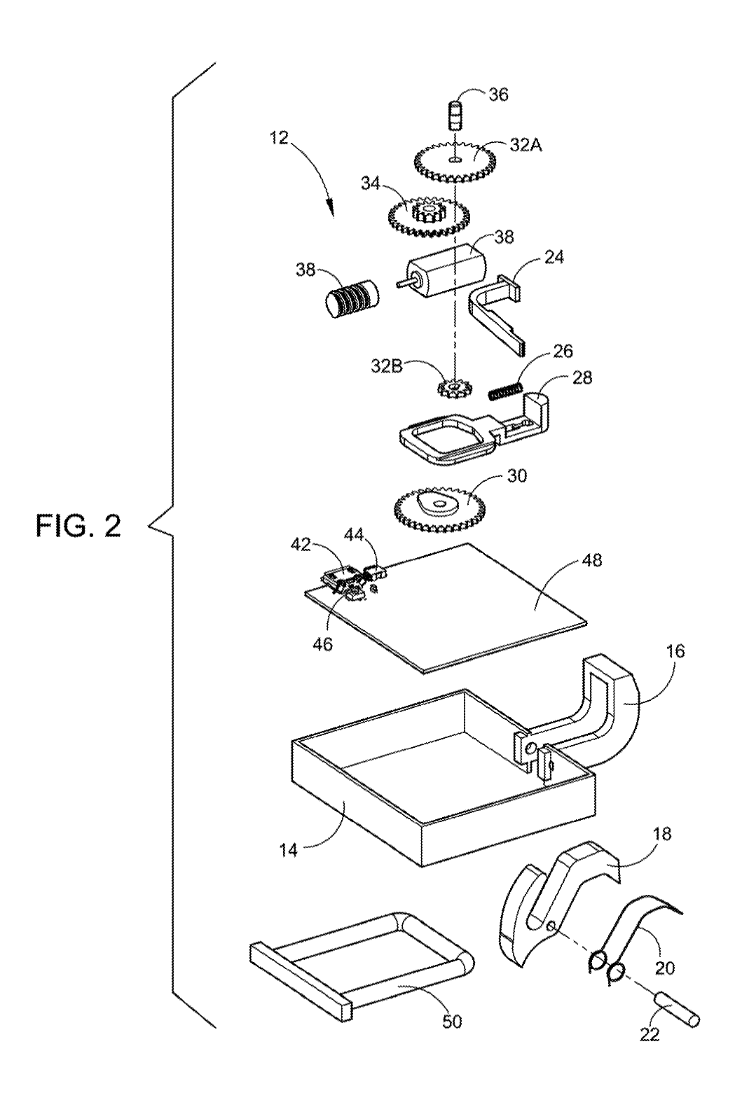

FIG. 2 depicts an exploded view of the Biometric and Bluetooth enabled vehicle Console and Glove Box Lock components 12 illustrate the same components as described in FIG. 1 with the addition of the consoles, glove boxes, trunks and access hatch locking bar 50.

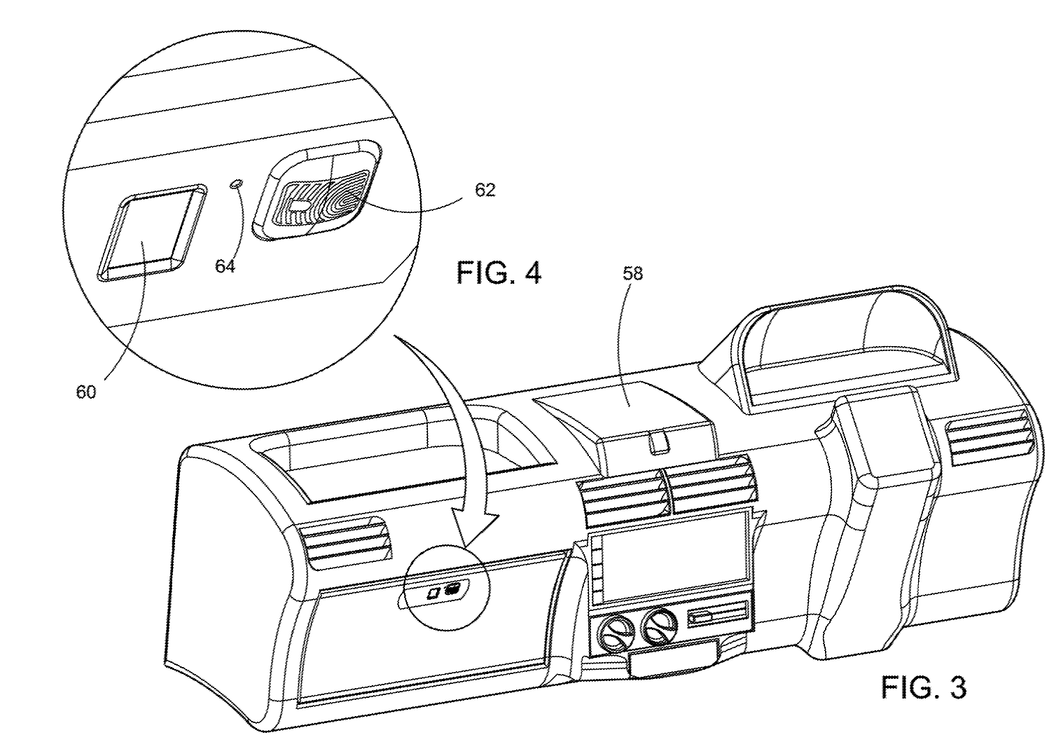

FIG. 3 depicts a perspective view of a typical vehicle instrument panel 58 incorporating the Biometric and Bluetooth enabled vehicle Console and Glove Box Lock 10.

FIG. 4 depicts a detail view of a portion of the instrument panel 58 illustrating the home button 60 that wakes up the fingerprint sensor 62 of the Biometric and Bluetooth system. The small hole between the home button 60 and the fingerprint 62 sensor is the system reset button 64 to be activated by pencil, pen point or small wire.

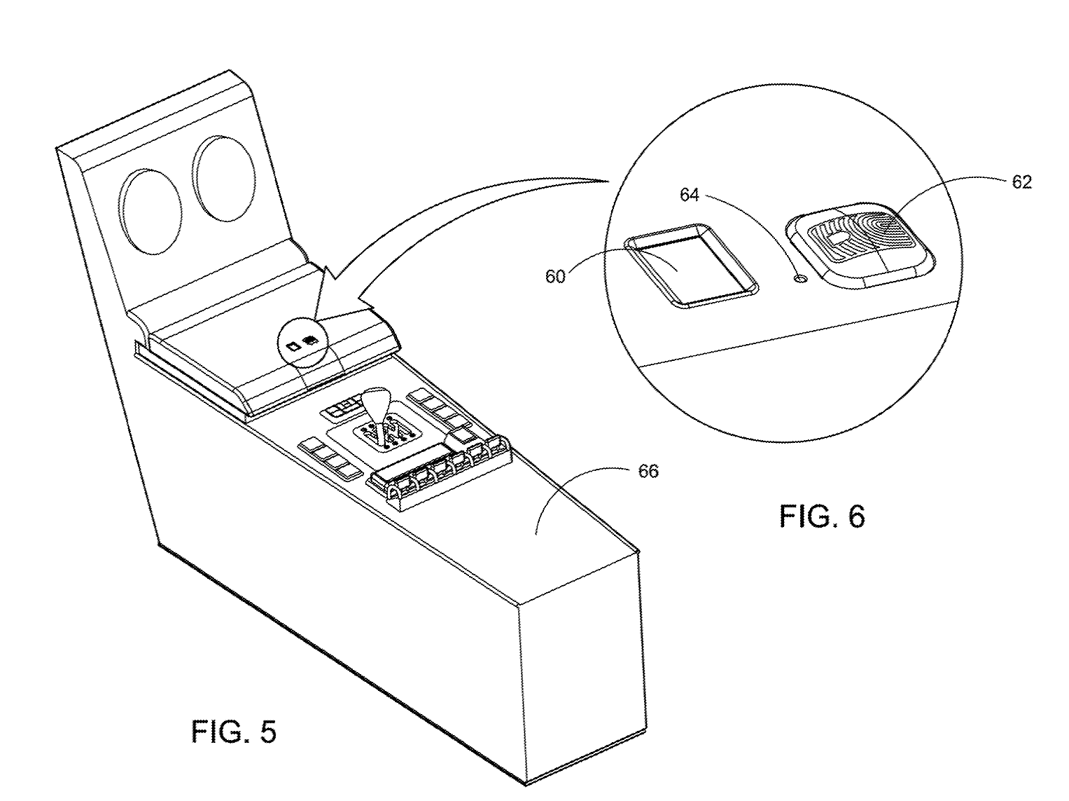

FIG. 5 depicts a perspective view of a typical vehicle center console 66 incorporating the Biometric and Bluetooth enabled vehicle Console and Glove Box Lock 10.

FIG. 6 depicts a detail view of a portion of the center console illustrating the Biometric and Bluetooth activation buttons incorporating the home button 60 and the fingerprint sensor 62 of the Biometric and Bluetooth system with the small hole for the system reset button 64 to be activated by pencil, pen point or small wire.

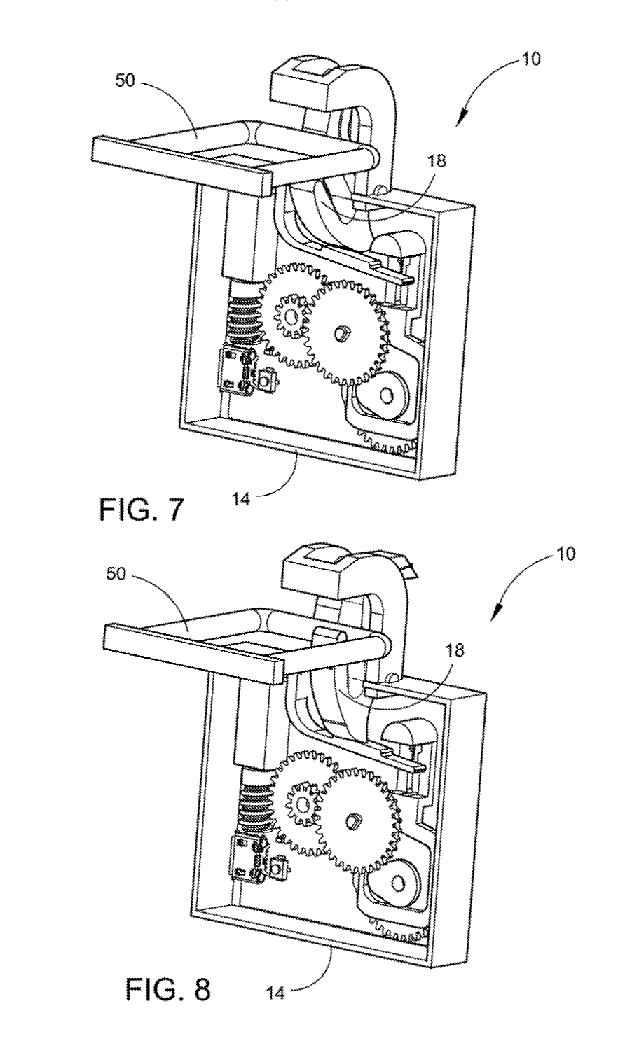

FIG. 7 depicts a perspective view of the Biometric and Bluetooth enabled vehicle Console and Glove Box Lock 10 with the latching mechanism 18 prior to the engagement with the locking bar 50.

FIG. 8 depicts a perspective view of the Biometric and Bluetooth enabled vehicle Console and Glove Box Lock 10 with the latching mechanism 18 in a partial engagement position with the locking bar 50.

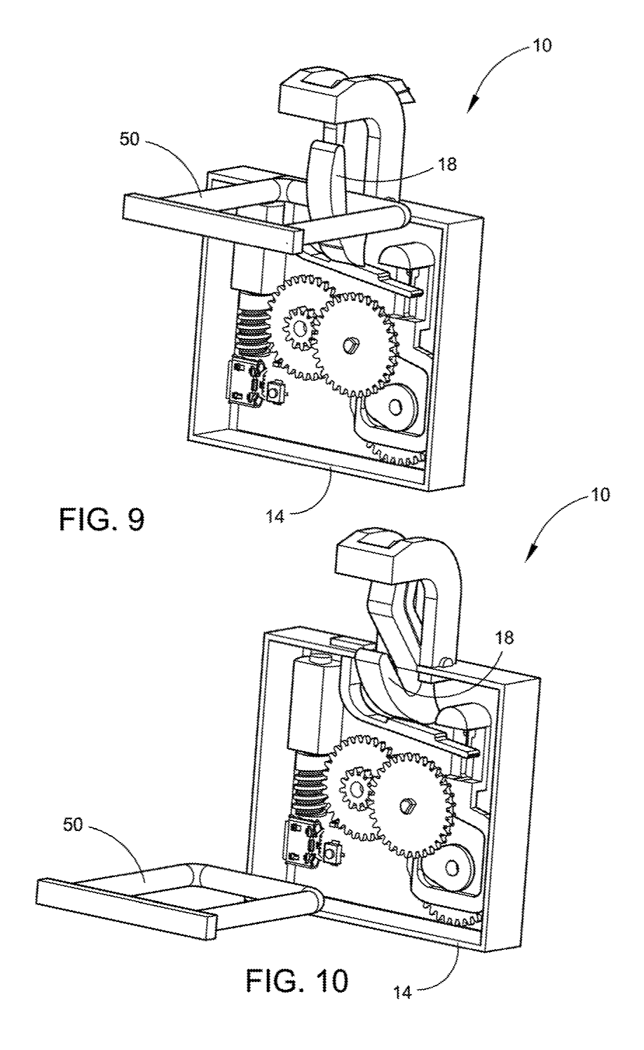

FIG. 9 depicts a perspective view of the Biometric and Bluetooth enabled vehicle Console and Glove Box Lock 10 with the latching mechanism 18 in a full locking engagement position with the locking bar 50.

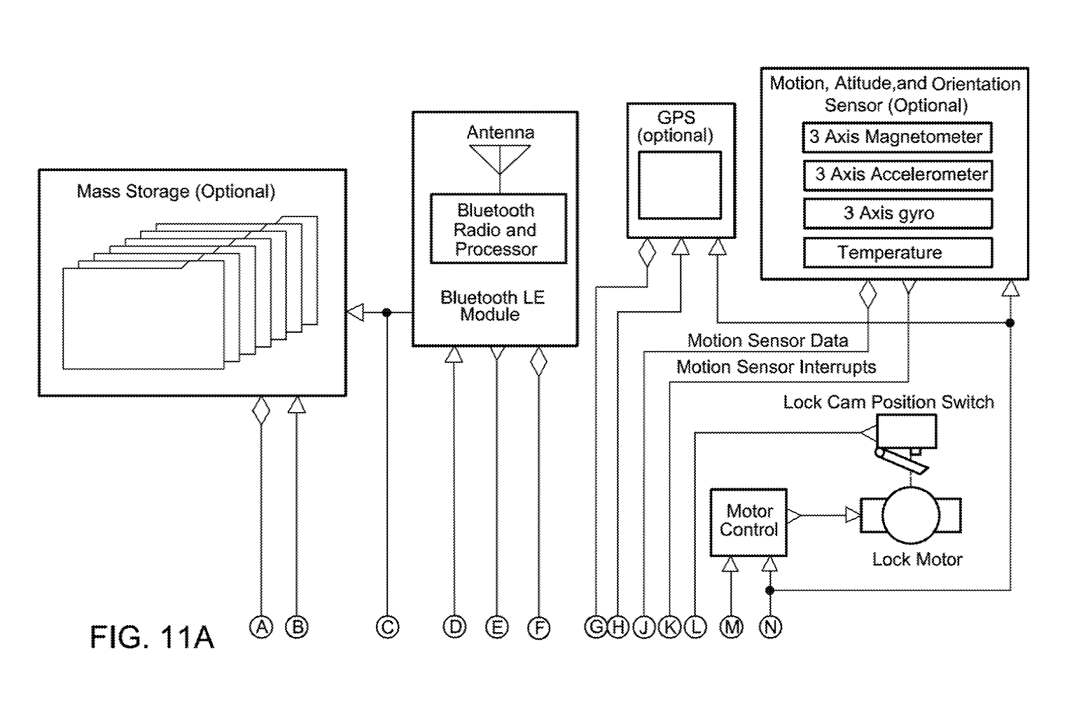

FIG. 10 depicts a perspective view of the Biometric and Bluetooth enabled vehicle Console and Glove Box Lock 10 with the latching mechanism 18 in the open position separated from the locking bar 50.

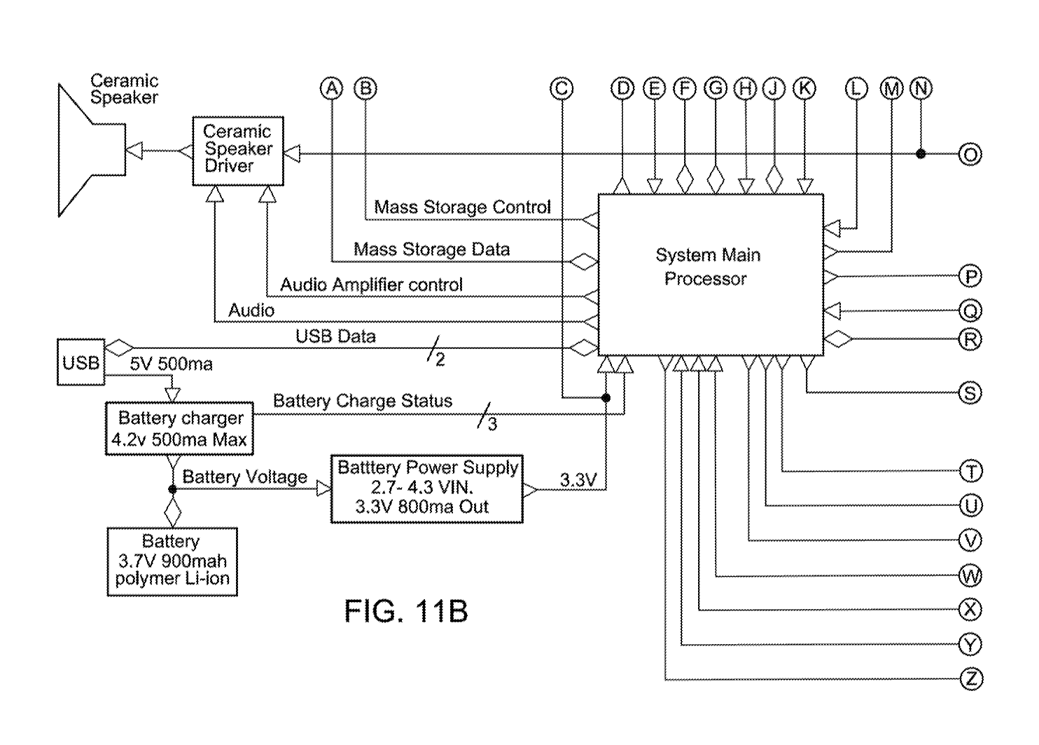

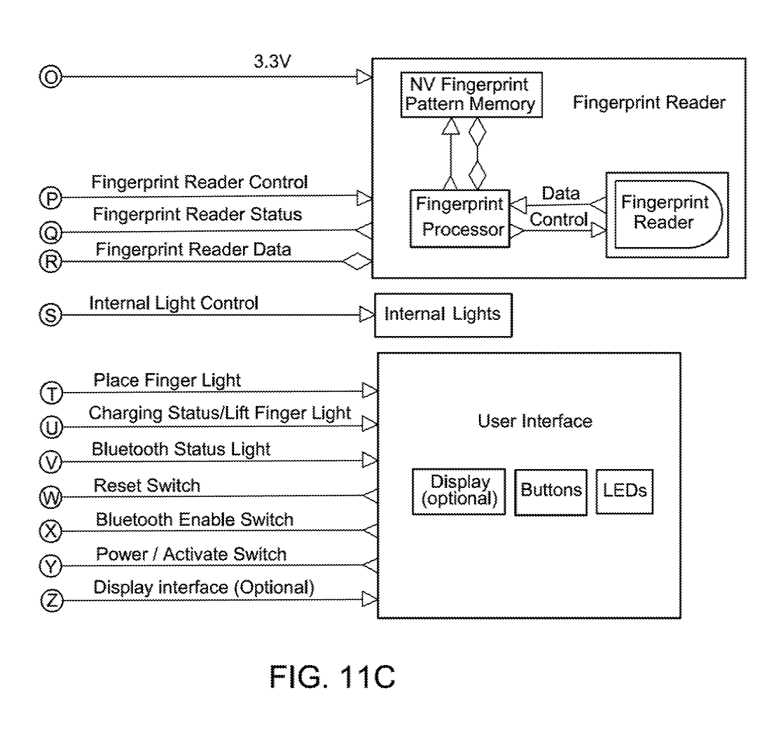

FIG. 11A depicts a block diagram illustration of the system components for the Biometric and Bluetooth enabled vehicle Console and Glove Box Lock 10 assembly including the motor control, lock, Bluetooth antenna and Bluetooth module as well as optional mass storage, GPS and motion sensor.

Bluetooth is a wireless technology standard for exchanging data over short distances (using short-wavelength UHF radio waves in the ISM band from 2.4 to 2.485 GHz) from fixed and mobile devices, and building personal area networks (PANs). Invented by telecom vendor Ericsson in 1994, it was originally conceived as a wireless alternative to RS-232 data cables. It can connect several devices, overcoming problems of synchronization.

Bluetooth operates at frequencies between 2402 and 2480 MHz, or 2400 and 2483.5 MHz including guard bands 2 MHz wide at the bottom end and 3.5 MHz wide at the top. This is in the globally unlicensed (but not unregulated) Industrial, Scientific and Medical (ISM) 2.4 GHz short-range radio frequency band. Bluetooth uses a radio technology called frequency-hopping spread spectrum. Bluetooth divides transmitted data into packets, and transmits each packet on one of 79 designated Bluetooth channels. Each channel has a bandwidth of 1 MHz. It usually performs 800 hops per second, with Adaptive Frequency-Hopping (AFH) enabled. Bluetooth low energy uses 2 MHz spacing, which accommodates 40 channels.

Originally, Gaussian frequency-shift keying (GFSK) modulation was the only modulation scheme available. Since the introduction of Bluetooth 2.0+EDR, π/4-DQPSK (Differential Quadrature Phase Shift Keying) and 8DPSK modulation may also be used between compatible devices. Devices functioning with GFSK are said to be operating in basic rate (BR) mode where an instantaneous data rate of 1 Mbit/s is possible. The term Enhanced Data Rate (EDR) is used to describe π/4-DPSK and 8DPSK schemes, each giving 2 and 3 Mbit/s respectively. The combination of these (BR and EDR) modes in Bluetooth radio technology is classified as a “BR/EDR radio”.

Bluetooth is a packet-based protocol with a master-slave structure. One master may communicate with up to seven slaves in a piconet. All devices share the master's clock. Packet exchange is based on the basic clock, defined by the master, which ticks at 312.5 μs intervals. Two clock ticks make up a slot of 625 μs, and two slots make up a slot pair of 1250 μs. In the simple case of single-slot packets the master transmits in even slots and receives in odd slots. The slave, conversely, receives in even slots and transmits in odd slots. Packets may be 1, 3 or 5 slots long, but in all cases the master's transmission begins in even slots and the slave's in odd slots.

The above is valid for “classic” BT. Bluetooth Low Energy, introduced in the 4.0 specification, uses the same spectrum but somewhat differently.

Bluetooth is a standard wire-replacement communications protocol primarily designed for low-power consumption, with a short range based on low-cost transceiver microchips in each device. Because the devices use a radio (broadcast) communications system, they do not have to be in visual line of sight of each other, however a quasi optical wireless path must be viable. Range is power-class-dependent, but effective ranges vary in practice; see the table on the right. Officially Class 3 radios have a range of up to 1 meter (3 ft.), Class 2, most commonly found in mobile devices, 10 meters (33 ft.), and Class 1, primarily for industrial use cases, 100 meters (300 ft.). Bluetooth Marketing qualifies that Class 1 range is in most cases 20-30 meters (66-98 ft.), and Class 2 range 5-10 meters (16-33 ft.).

The effective range varies due to propagation conditions, material coverage, production sample variations, antenna configurations and battery conditions. Most Bluetooth applications are for indoor conditions, where attenuation of walls and signal fading due to signal reflections make the range far lower than specified line-of-sight ranges of the Bluetooth products. Most Bluetooth applications are battery powered Class 2 devices, with little difference in range whether the other end of the link is a Class 1 or Class 2 device as the lower powered device tends to set the range limit. In some cases, the effective range of the data link can be extended when a Class 2 device is connecting to a Class 1 transceiver with both higher sensitivity and transmission power than a typical Class 2 device. Mostly, however, the Class 1 devices have a similar sensitivity to Class 2 devices. Connecting two Class 1 devices with both high sensitivity and high power can allow ranges far in excess of the typical 100 m, depending on the throughput required by the application. Some such devices allow open field ranges of up to 1 km and beyond between two similar devices without exceeding legal emission limits.

Bluetooth uses the microwave radio frequency spectrum in the 2.402 GHz to 2.480 GHz range. Maximum power output from a Bluetooth radio is 100 mW for class 1, 2.5 mW for class 2, and 1 mW for class 3 devices. Even the maximum power output of class 1 is a lower level than the lowest powered mobile phones. UMTS and W-CDMA outputs 250 mW, GSM 1800/1900 outputs 1000 mW, and GSM850/900 outputs 2000 mW.

Radio Frequency Communications (RF COMM) is a cable replacement protocol used to generate a virtual serial data stream. RF COMM provides for binary data transport and emulates EIA-232 (formerly RS-232) control signals over the Bluetooth baseband layer, i.e. it is a serial port emulation. RF COMM provides a simple reliable data stream to the user, similar to TCP. It is used directly by many telephony related profiles as a carrier for AT commands, as well as being a transport layer for OBEX over Bluetooth. Many Bluetooth applications use RFCOMM because of its widespread support and publicly available API on most operating systems. Additionally, applications that used a serial port to communicate can be quickly ported to use RFCOMM. Therefore, it is anticipated that Bluetooth and radio frequency communications (RF COMM) will be entirely interchangeable throughout this patent application and within the claims.

FIG. 11B depicts a block diagram illustration of the hardware components for the Biometric and Bluetooth enabled vehicle Console and Glove Box Lock 10 assembly, including the main processor, speaker driver and speaker, as well as the USB port and battery power supply configurations.

FIG. 11C depicts a block diagram illustration hardware and software components for the Biometric and Bluetooth enabled vehicle Console and Glove Box Lock 10 assembly, including the fingerprint reader, internal lights and user interface.

In this regard, referring now to FIGS. 11A, 11B and 11C, the outline provides a hardware design for a Biometric and Bluetooth enabled vehicle Console and Glove Box Lock 10 with all optional equipment included. Items listed as ‘standard equipment’ will be included on all Biometric and Bluetooth enabled vehicle Console and Glove Box Lock 10 product designs. Items listed as ‘optional equipment’ may be included or omitted in any combination in a specific design as may be required by a final product definition.

System Processor (standard equipment) Controls the overall operation of the unit.
a. Interprets the user's inputs and convert them into commands which control the fingerprint enrollment and identification process.
b. Controls lock motor and monitors lock motor position feedback operation.
c. Controls and interprets commands passed from the user's external Bluetooth/RF COMM device.
d. Manages system power usage.
e. Controls the operation of all LED's (Status LEDs and Hood Light).
f. Monitors and records motion sensor data.
g. Monitors and records temperature sensor readings.
h. Manages the Real Time Clock for time-lock and alarm operation.
i. Supports USB communication for direct connect setup and firmware updating.
j. Monitors the battery voltage and reports battery status via status LEDs and Bluetooth.
k. Optionally monitors and records GPS Data.

Bluetooth LE Module (Standard Equipment)

Control the Bluetooth/radio frequency (RF) communications (COMM) link to the users' smartphone or another compatible intelligent device. Receives commands and alerts from the external device and passes them to the System Processor for action. Also receives command and control data from the System Processor and passes that data to the external device via the Bluetooth link. It is anticipated that Bluetooth and radio frequency communications (RF COMM) will be entirely interchangeable throughout this patent application and within the claims.

Fingerprint Sensor (Standard Equipment)

The device on which the users place their finger is to enroll a fingerprint or to unlock the device.

Fingerprint Coprocessor (Standard Equipment)

Receives commands from the System Processor and then controls the operation of the fingerprint sensor.

USB Interface (Standard Equipment)

The USB interface is used both to provide charging power for the battery and to control and setup the device with the individual user preferences and also allows reading the mass storage memory if equipped.

Battery (Standard Equipment)

The battery provides all power to the system during normal operation.

Power Supply (Standard Equipment)

Provide the system with the regulated voltages that are required for the system to operate.

Battery Charger (Standard Equipment)

Provides controls and monitors the battery charge cycle when the unit is plugged into a USB port or USB wall charger.

Status LEDs (Standard Equipment)

The Status LEDs are used to convey unit status and also to prompt the user to perform some action like placing a finger on or lifting a finger from the fingerprint touch sensor.
a. Green LED blinks slowly when battery is charging and is on solid when the battery if fully charged. One long blink indicates user should place their finger on the fingerprint sensor. Green LED is off when in standby mode.
b. Red LED flickers at a slow rate to indicate the battery is in need of charging.

One long blink indicates the user should lift their finger from the fingerprint sensor. Red LED is off when in standby mode.
c. Blue LED conveys the current state of the Bluetooth link.

Internal Lighting (Standard Equipment)

These lights illuminate the contents of the vehicle console and glove box momentarily when opened in low light conditions.

Lock Status Switch (Standard Equipment)

This switch signals the main processor when the lock Motor has completed the full Unlock/Relock cycle.

Activate/Power Button (Standard Equipment)

Powers the unit on if it is off and requests the user to input a fingerprint to unlock the unit. If the unit is already on or in standby mode, the unit will just request that the user inputs a fingerprint to unlock the unit.

Bluetooth Enable Button (Standard Equipment)

Used to enable and disable the Bluetooth link to the user's external device.

Reset Button (Standard Equipment)

The reset button is accessed via a small diameter hole somewhere on the device. The button is activated by inserting the tip of a paperclip straight into the hole until clicks. This is used to restart the main processor in the event of trouble. The unit will restart with all previous settings intact. An alarm will sound for a few seconds and the user will be prompted to place their finger on the fingerprint reader.

Lock Motor Control (Standard Equipment)

Provides power to the Lock Motor when requested by the System Processor.

Lock Motor (Standard Equipment)

Electromechanical device which unlocks and relocks the unit.

Alarm Amplifier (Standard Equipment)

Amplifies the low power audio signals from main processor to the high power signal required by the alarm speaker.

Alarm Speaker (Standard Equipment)

Provides the sounds which alert the user about a status change of the device which requires their attention.

Wi-Fi Connectivity (Optional Equipment)

Allows long distance control, access and monitoring of the unit.

GPS Sensor (Optional Equipment)

Allows global position information to be monitored and recorded.

Temperature Sensor (Optional Equipment)

Allows the monitoring of environmental conditions in the device which may be detrimental to the contents. An alarm may be triggered or the temperature profile may be recorded over time for later analysis.

Axis Accelerometer (Optional Equipment)

Can be used to prevent the device from being opened while not being held at a specific angle. Can also be used to detect or record rough handling of the device. May also trigger an alarm if not handled as instructed.

Axis Magnetometer (Optional Equipment)

Can be programmed to trigger an alarm if the device is physically moved. Provides a virtual lock in place function.

Axis Gyroscope (Optional Equipment)

May be programmed to trigger an alarm when the device is rotated in any axis at a rate greater than a fixed value.

Display (Optional Equipment)

A custom display may be added for applications that require more complex user interaction.

Mass Storage Device (Option Equipment)

Allows storage and recall of sensor history data such as temperature, motion and when and where the device was opened.

The Biometric and Bluetooth enabled vehicle Console and Glove Box Lock 10 shown in the drawings and described in detail herein disclose arrangements of elements of particular construction and configuration for illustrating preferred embodiments of structure and method of operation of the present application. It is to be understood, however, that elements of different construction and configuration and other arrangements thereof, other than those illustrated and described may be employed for providing a Biometric and Bluetooth enabled vehicle Console and Glove Box Lock 10 in accordance with the spirit of this disclosure, and such changes, alternations and modifications as would occur to those skilled in the art are considered to be within the scope of this design as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. A biometric and Bluetooth enabled vehicle console and glove box lock system comprising:
a frame, incorporating a locking latch and lock solenoid/motor;
a biometric access module;
a Bluetooth/radio frequency (RF) communications (COMM) access module;
wherein access to the locking latch for locking and unlocking the vehicle console and glove box lock is controlled by said biometric access module and said Bluetooth/RF COMM communications access module; and
whereby said vehicle console and glove box lock system is controllable via an application on a smartphone, tablet, FOB or a computer.

2. The biometric and Bluetooth enabled vehicle console and glove box lock system according to claim 1, wherein said frame, incorporating a locking latch includes any locking compartment within a vehicle as well as the vehicle doors, vehicle hood and vehicle trunk locks.

3. The biometric and Bluetooth enabled vehicle console and glove box lock system according to claim 1, wherein said biometric access module and said Bluetooth/RF COMM communications access module include indirect operational control of said locking latch by an on-board system processor in communication with an application on a smartphone, tablet or a computer.

4. The biometric and Bluetooth enabled vehicle console and glove box lock system according to claim 1, wherein said on-board system processor includes a system processor to control the electronic, mechanical and communications operations of the vehicle console and glove box locking unit.

5. The biometric and Bluetooth enabled vehicle console and glove box lock system according to claim 1, wherein said system processor interprets the user's inputs and converts them into commands which control the fingerprint enrollment and identification process.

6. The biometric and Bluetooth enabled vehicle console and glove box lock system according to claim 1, wherein said system processor controls said solenoid/lock motor and monitors the solenoid/lock motor position feedback operations.

7. The biometric and Bluetooth enabled vehicle console and glove box lock system according to claim 1, wherein said Bluetooth/RF COMM communications access module includes a system processor which controls and interprets commands passed from the user's external Bluetooth or RF COMM device.

8. The biometric and Bluetooth enabled vehicle console and glove box lock system according to claim 1, wherein said vehicle console and glove box lock system includes a system processor, a GPS sensor, one or more LED's including status LED's and an incorporated light, a motion sensor, a temperature sensor, and a real time clock.

9. The biometric and Bluetooth enabled vehicle console and glove box lock system according to claim 1, wherein said system processor manages system power usage, controls the operation of all LED's including status LED's and an incorporated light, monitors and records GPS position data, motion sensor data, monitors and records temperature sensor readings, and manages the real time clock for time-lock and alarm operations.

10. The biometric and Bluetooth enabled vehicle console and glove box lock system according to claim 1, wherein said system processor facilitates access to the locking latch for locking and unlocking the vehicle console and glove box lock and controls said biometric access module and said Bluetooth/RF COMM communications access module.

11. A method for making a biometric and Bluetooth enabled vehicle console and glove box lock system, comprising the steps of:
providing a frame, incorporating a locking latch and solenoid/lock motor;
connecting a biometric access module to said frame; and
connecting a Bluetooth/radio frequency (RF) communications (COMM) access module to said frame;
wherein access to the locking latch for locking and unlocking the vehicle console and glove box lock is controlled by said biometric access module and said Bluetooth/RF COMM communications access module; and
whereby said the vehicle console and glove box lock system is controllable via an application on a smartphone, tablet, FOB or a computer.

12. The method for making a biometric and Bluetooth enabled vehicle console and glove box lock system according to claim 11, wherein said frame, incorporating a locking latch includes any locking compartment within a vehicle as well as the vehicle doors, vehicle hood and vehicle trunk locks.

13. The method for making a biometric and Bluetooth enabled vehicle console and glove box lock system according to claim 11, wherein said biometric access module and said Bluetooth/RF COMM communications access module include indirect operational control of said locking latch by an on-board system processor in communication with an application on a smartphone, tablet or a computer.

14. The method for making a biometric and Bluetooth enabled vehicle console and glove box lock system according to claim 11, wherein said on-board system processor includes a system processor to control the electronic, mechanical and communications operations of the vehicle console and glove box locking unit.

15. The method for making a biometric and Bluetooth enabled vehicle console and glove box lock system according to claim 11, wherein said system processor interprets the user's inputs and converts them into commands which control the fingerprint enrollment and identification process.

16. The method for making a biometric and Bluetooth enabled vehicle console and glove box lock system according to claim 11, wherein said system processor controls said solenoid/lock motor and monitors the solenoid/lock motor position feedback operations.

17. The method for making a biometric and Bluetooth enabled vehicle console and glove box lock system according to claim 11, wherein said Bluetooth/RF COMM communications access module includes a system processor which controls and interprets commands passed from the user's external Bluetooth/RF COMM device, whereby said vehicle console and glove box lock system is controllable via an application on a smartphone, tablet, FOB or a computer.

18. The method for making a biometric and Bluetooth enabled vehicle console and glove box lock system according to claim 11, wherein said vehicle console and glove box lock system includes a system processor, one or more LED's including status LED's and a hood light, a GPS sensor, a motion sensor, a temperature sensor, and a real time clock.

19. The method for making a biometric and Bluetooth enabled vehicle console and glove box lock system according to claim 11, wherein said system processor manages system power usage, controls the operation of all LED's including status LED's and a hood light, monitors and records GPS position data, motion sensor data, monitors and records temperature sensor readings, and manages the real time clock for time-lock and alarm operations.

20. The method for making a biometric and Bluetooth enabled vehicle console and glove box lock system according to claim 11, wherein said system processor facilitates access to the locking latch for locking and unlocking the vehicle console and glove box lock and controls said biometric access module and said Bluetooth/RF COMM communications access module.
